(19) United States
(12) Patent Application Publication
(10) Pub. No.: US 2005/0191877 A1
(43) Pub. Date: Sep. 1, 2005

(54) Electrical connector

(76) Inventor: Peter Huang, Taipei Hsien (TW)

Correspondence Address: PAI PATENT & TRADEMARK LAW FIRM, 1001 FOURTH AVENUE, SUITE 3200, SEATTLE, WA, 98154, US

(21) Appl. No.: 10/790,490

(22) Filed: Mar. 1, 2004

(51) Int. Cl. H01R 12/00

(52) U.S. Cl. 439/74

(57) ABSTRACT

An electrical connector comprising a rectangular insulated body and a plurality of electrical pins has been described and claimed. The insulated body is made of a liquid crystal polymer (LCP) with good heat resistance and flow molding properties; the electrical pins are made of phosphor bronze with better elasticity. The insulated body has a bottom wall for contacting PCB, a plurality of pin containers passing through the bottom wall for containing the electrical pins, and a plurality of protruding pillars under the bottom wall, corresponding in position to holes on the PCB such that the insulated body can be positioned accurately on the PCB with the protruding pillars. A soldering section is on each electrical pin to be soldered onto the PCB using SMT (Surface Mount Technology).

### BACKGROUND OF THE INVENTION

I. Field of the Invention This invention relates generally to an electrical connector and, more specifically, to an electrical connector that connects two circuit boards.

II. Description of the Related Art Heretofore, it is known that the board to board female connector, as shown in FIG. 1, consists of an insulated body 8 made of injection plastic material in rectangular shape having a first side wall 81 and a second side wall 82 on the longer direction sides, and a bottom wall 83 linking the bottom of the first side wall 81 and the bottom of the second side wall 82; the first side wall 81, the second side wall 82 and the bottom wall 83 together form a concave connection section 84 for receiving a board to board male connector (not shown). A plurality of pin containers 85 pass through the bottom wall 83 of the insulated body 8, link to the connection section 84 and stretch to the first side wall 81 and the second side wall 82; each pin container 85 can accommodate a connection pin 9 inside.

The electrical connector described above is often made of materials that have poor heat resistance and flow molding properties. Moreover, the connection pin 9 might not have good elasticity, thus compromising the stability of the connection.

### BRIEF SUMMARY OF THE INVENTION

It is therefore a primary object of the invention to provide an electrical connector for electrical board to board connection with better heat resistance, better flow molding properties, and better pin elasticity.

In order to achieve the objective set forth, an electrical connector in accordance with the present invention comprises a rectangular insulated body and a plurality of electrical pins; the insulated body is made of a liquid crystal polymer (LCP) with good heat resistance and flow molding properties; the electrical pins are made of phosphor bronze with better elasticity; the insulated body has a bottom wall for contacting a printed circuit board (PCB); a plurality of pin containers pass through the bottom wall to contain the electrical pins; a plurality of protruding pillars are provided under the bottom wall, corresponding in position to the holes on the circuit board such that the insulated body can be positioned accurately on the circuit board with the protruding pillars. Furthermore, a soldering section on each electrical pin is to be soldered onto the PCB using SMT (Surface Mount Technology).

### BRIEF DESCRIPTION OF THE DRAWINGS

That the above-mentioned object of the present invention has been accomplished will become apparent from the following description and its accompanying drawings as follows:

FIG. 1 is a perspective view of the prior art;

FIG. 2 is a perspective view of the first embodiment of the present invention;

FIG. 3 is another perspective view of the first embodiment of the present invention;

FIG. 4 is an assembly view of the first embodiment of the present invention;

FIG. 5 is a perspective view of the second embodiment of the present invention;

FIG. 6 is another perspective view of the second embodiment of the present invention;

FIG. 7 is an assembly view of the second embodiment of the present invention.

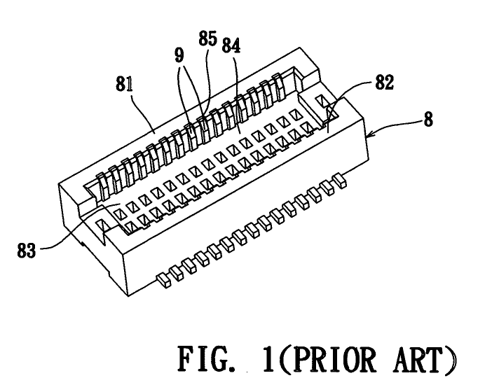

### DETAILED DESCRIPTION OF THE PREFERRED EMBODIMENT

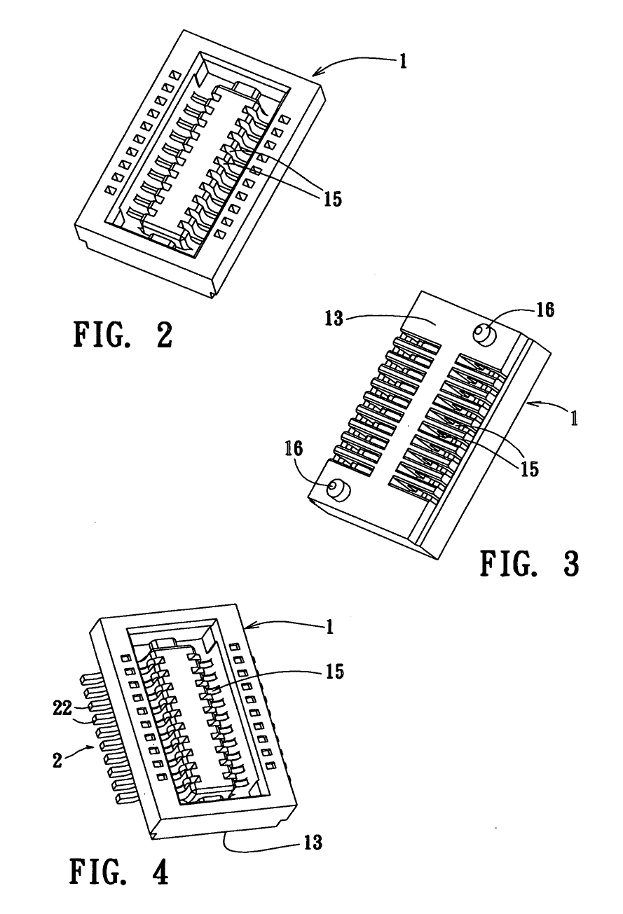

Referring to FIG. 2 to FIG. 4, the female connector as a preferred embodiment of the present invention comprises a rectangular insulated body 1 and a plurality of electrical pins 2; the insulated body 1 comprises a bottom wall 13 for contacting a PCB (not shown), a plurality of pin containers 15 passing through the bottom wall 13 for containing the electrical pins 2, and a plurality of protruding pillars 16 under the bottom wall 13, corresponding in position to the holes on the PCB such that the insulated body 1 can be positioned accurately on the PCB with the protruding pillars 16. A soldering section 22 on each electrical pin 2 is to be soldered onto the PCB using SMT (Surface Mount Technology).

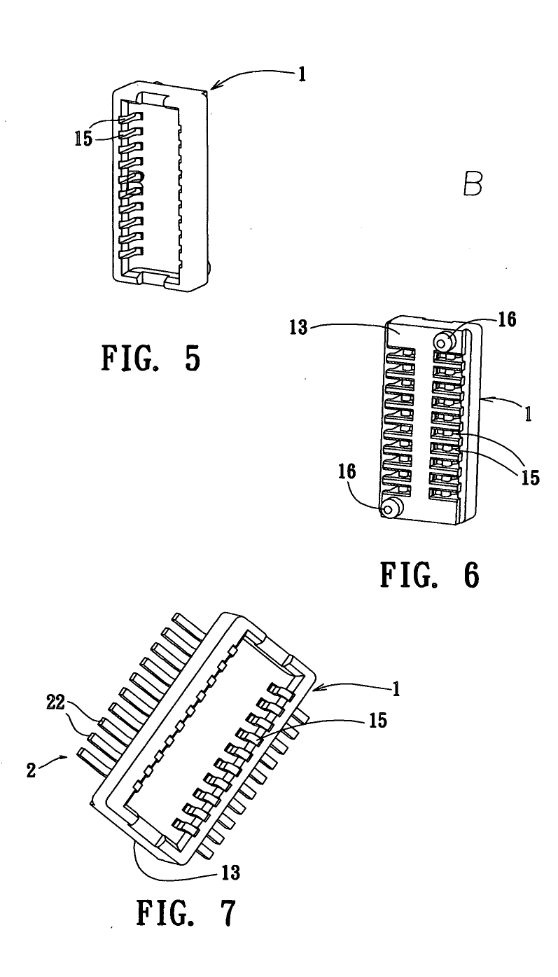

Referring to FIG. 5 to FIG. 7, the male connector as another embodiment of the present invention comprises a rectangular insulated body 1 and a plurality of electrical pins 2; the electrical pins 2 are inside the corresponding pin containers 15; a plurality of protruding pillars 16 are under the bottom wall 13; a soldering section 22 is on the electrical pin 2.

A major feature of the present invention is that the insulated body 1 is made of a liquid crystal polymer (LCP), which possesses very good heat resistance and flow molding properties. The specifications of the LCP are shown in the following Table:

TABLE
General physical properties

| Item | | Unit | Testing method | E130i |
|---|---|---|---|---|
| Density | | g/cm | ISO1183 | 1.61 |
| Tensile strength* | | MPa | ASTM D638 | 175 |
| Tensile elongation* | | % | ASTM D638 | 2.0 |
| Flexural strength | | MPa | ISO178 | 220 |
| Flexural modulus | | MPa | ISO178 | 15,000 |
| Flexural strain | | % | ISO178 | 2.3 |
| Charpy impact | | kJ/m² | ISO179/1eA | 35 |
| strength | | | | |
| DTUL@1.8 MPa | | ° C. | IS075-1, 2 | 280 |
| Mold shrinkage ratio | | % | Flow | 0.02 |
| 80 mm sq/1 mmt | | % | TD | 0.54 |
| | | Injection Pressure | MPa | 59 |
| Volume resistivity | | Ω · cm | IEC60093 | 1.0/10¹⁴ |
| Surface resistivity | | Ω | IEC60093 | 1.0/10¹⁴ |
| Dielectric | 1 KHz | (1 Mhz) | IEC60250 | 4.3 |
| constant | 1 MHz | | | 3.8 |
| | 10 GHz | | | 3.6 |
| Dielectric | 1 KHz | 10/(1 Mhz) | IEC60250 | 0.017 |
| dissipation | 1 MHz | | | 0.032 |
| factor | 10 GHz | | | 0.007 |
| Dielectric | (1 mm) | MV/m (1 Mhz) | IEC243-1 | 44 |
| breakdown | (3 mm) | | | 24 |
| strength | | | | |

| | | | |
|---|---|---|---|
| Tracking resistance | v | IEC60112 | 125 |
| Arc resistance | s | — | 144 |

Another major feature is that the electrical tips 2 are made of phosphor bronze with better elasticity. The preferred phosphor bronze is that which conforms to the JIS (Japanese Industrial Standards) H3270 C-5191. Moreover, the protruding pillars 16 are positioned such that they can be inserted onto the corresponding holes (not shown) on the circuit board to increase the effectiveness of SMT.

While two preferred embodiments of the present invention have been shown and described in detail, it will be readily understood and appreciated that numerous omissions, changes and additions may be made without departing from the spirit and scope of the invention.

1. An electrical connector comprising:
a rectangular insulated body and a plurality of electrical pins,
wherein said insulated body is made of a liquid crystal polymer and comprises
a bottom wall for contacting a PCB;
a plurality of pin containers passing through said bottom wall for containing said electrical pins; and
a plurality of protruding pillars under said bottom wall, corresponding in position to holes on the PCB, for accurately positioning said insulated body onto the PCB;
and said electrical pins are made of a phosphor bronze and each of said electrical pins includes
a soldering section to be soldered onto the PCB using surface mount technology.

2. The electrical connector as claimed in claim 1, wherein the phosphor bronze for the electrical pins conforms to the JIS (Japanese Industrial Standards) H3270 C-5191.
